(19) United States
(12) Patent Application Publication
(10) Pub. No.: US 2025/0340033 A1
(43) Pub. Date: Nov. 6, 2025

(54) ROTARY TABLET PRESS AND METHOD FOR LUBRICATING PRESSING PUNCHES USING A ROTARY TABLET PRESS

(71) Applicant: Fette Compacting GmbH, Schwarzenbek (DE)

(72) Inventors: Lasse Tomsett, Hamburg (DE); Stefan Lüdemann, Hamburg (DE); Werner Seifert, Wentorf (DE); Jörg Gaedecke, Geesthacht (DE)

(73) Assignee: Fette Compacting GmbH, Schwarzenbek (DE)

(21) Appl. No.: 19/196,956

(22) Filed: May 2, 2025

(30) Foreign Application Priority Data
May 3, 2024 (DE) 102024112540.3

(51) Int. Cl. B30B 15/00; B30B 11/08

(52) U.S. Cl. CPC B30B 15/0088; B30B 11/08

(57) ABSTRACT

A rotary tablet press, comprising a lubrication device configured to lubricate at least one of the upper and the lower pressing punches with a lubricant. The lubrication device includes a lubricant reservoir configured to hold a lubricant and a stationary applicator connected to the lubricant reservoir and configured to apply the lubricant to at least one of the upper pressing punches and the lower pressing punches rotating past the stationary applicator. A control apparatus is configured to individually control an amount of lubricant applied by the stationary applicator to the at least one of the upper pressing punches and the lower pressing punches for different upper or lower pressing punches.

### CROSS-REFERENCE TO RELATED APPLICATION

This application claims the benefit and the priority of German Patent Application No. 10 2024 112 540.3, filed on May 3, 2024. The entire contents of said application is herein incorporated by reference.

### TECHNOLOGICAL FIELD

The following disclosure is directed to embodiments of a rotary tablet press. In some embodiments, the rotary press includes a rotor that can be rotated by means of a rotary drive, wherein the rotor has an upper punch guide for upper pressing punches and a lower punch guide for lower pressing punches as well as a die plate arranged between the punch guides, wherein the pressing punches cooperate with cavities of the die plate. In some embodiments, the rotary tablet press further comprises a filling apparatus by means of which powder material to be pressed is filled into the cavities of the die plate. In some embodiments, the rotary tablet press comprises a pressure apparatus having an upper pressure unit and a lower pressure unit, which cooperate with the upper pressing punches and with the lower pressing punches during operation in order to press the powder material in the cavities of the die plate into tablets. In some embodiments, the rotary tablet press has an ejection apparatus for ejecting the tablets. In some embodiments, the rotary tablet press further has a lubrication device for lubricating the upper and/or lower pressing punches with a lubricant. The disclosure is also directed to a method for lubricating upper and/or lower pressing punches using a rotary tablet press.

### BACKGROUND

In rotary tablet presses, a large number of upper and lower pressing punches are generally provided which are in each case assigned to one cavity of a die plate in pairs. During operation of the rotary tablet press, the upper and lower pressing punches rotate together with the die plate, wherein their axial movement is controlled by control cams and guided by upper and lower punch guides. During the course of the rotation, the die plate travels through various apparatuses of the rotary tablet press, namely a filling apparatus, in which powder material to be pressed is filled into the cavities of the die plate, and a pressure apparatus, in which the upper and lower pressing punches are pushed into the cavities by means of upper and lower pressure units, for example pressure rollers, in order to press the powder material into tablets. After the pressure apparatus, the upper pressing punches are guided upwards out of the cavities and the produced tablets in the cavities are pushed by the lower pressing punches onto the upper side of the die plate. By means of a scraper, for example, the tablets are then scraped off of the die plate into an output of the rotary tablet press, from where they are supplied for further processing.

The pressing punches of such rotary tablet presses must be lubricated regularly with a lubricant to avoid stiffness of the pressing punches, in particular in the punch guides. Usually, a lubricant is applied to the pressing punches via a dosing element and a lubrication pump. A lubrication felt can also be used. It is also known to introduce dry lubricant into the cavities of the die plate, in particular in order to achieve smooth plunging of the pressing punches into the cavities and to prevent powder material from sticking.

DE 201 07 072 U1 discloses a lower punch spraying apparatus for die lubrication in tableting machines. A spraying apparatus is directed towards the die of the die plate in such a way that the nozzle opening of a quick-action valve is aligned with the side wall of the lower punch in the lowest position of a lower punch. When the lower punch is plunged into the die, only the side wall should be wetted with lubricant in a cycle-controlled and finely dosed manner. The quick-action valve is connected via electrical lines to a control unit for determining the cycle frequency and the lubricant dosing depending on the rotor speed. By adjusting the valve electrically via a valve input, it should be possible to preset the amount of oil per pulse. This lubricates the dies of the die plate. The aim is to optimize the detachment of product from the walls of the dies in this way. The tablets produced in the dies should therefore be easy to detach due to the lubrication and not stick.

A large amount of lubricant is required for the conventional lubrication devices described above. The lubricant often does not reach the punches completely. Some of the lubricant gets past the pressing punches and is distributed in the interior of the rotary tablet press or, in the worst case, on a produced tablet. If lubrication felts are used, they may become dirty and their function may be impaired. Furthermore, in the prior art, long channels are provided within the rotor for supplying the lubricant, in which channels the lubricant must be distributed in order to reach the pressing punches. These channels can become blocked, which can lead to lubrication failure. Cleaning the channels is very time-consuming. In addition, the lubricant may be distributed unevenly between the channels. As a result, the pressing punches are lubricated to varying degrees. At the start of tablet production, the channels must first be filled with lubricant before the lubricant can reach the pressing punches.

The apparatus described in DE 201 07 072 U1 also does not make it possible to react to different lubrication requirements of individual pressing punches of the rotary tablet press. The amounts of oil applied via the valve can be adjusted between different production processes in the tableting machine or with a different configuration of the tableting machine. However, it is not possible to detect or react to changes in lubricant requirements that occur during a production process, in particular for individual pressing punches. In addition, the dies are only lubricated to optimize product detachment. Lubrication of the punch shaft or punch head is not provided. Instead, the pressing punches are only lubricated at their neck under the pressing surface. Increased wear of the punches, in particular on the punch shaft, is not prevented.

Proceeding from the prior art described above, the object of the invention is therefore to provide a rotary tablet press and a method of the type mentioned at the outset by means of which a targeted and economical application of lubricant is achieved and by means of which it is also possible to react to different lubricant requirements of individual pressing punches, such that, in particular, wear of the pressing punches can be effectively counteracted.

### BRIEF DESCRIPTION OF THE INVENTION

With regard to a rotary tablet press of the type mentioned at the outset, some embodiments of the rotary tablet press include a lubrication device including a lubricant reservoir and a stationary applicator connected to the lubricant reservoir for applying lubricant to upper and/or lower pressing punches rotating past the applicator with the rotor, and in that the lubrication device comprises a control apparatus which is configured to individually control an amount of lubricant applied by the applicator to the upper and/or lower pressing punches for different upper and/or lower pressing punches.

The basic structure of a rotary tablet press, as is the subject matter of the present invention, was explained at the outset. Reference is made to this. The tablets produced in the rotary tablet press may be pharmaceutical tablets. However, other tablets are also conceivable, such as dishwasher tablets or the like. According to embodiments of the invention, the lubrication device of the rotary tablet press has a lubricant reservoir and a stationary applicator connected to the lubricant reservoir for applying lubricant to the pressing punches rotating past the applicator with the rotor. The applicator is stationary, so it does not rotate together with the rotor of the rotary tablet press. The lubricant reservoir is also preferably stationary and, like the applicator, does not rotate with the rotor of the rotary tablet press. The lubrication device further comprises a control apparatus which is configured to control the applicator in such a way that the amount of lubricant applied by the applicator to the upper and/or lower pressing punches is controlled individually for different upper and/or lower pressing punches.

In some embodiments, the lubricant is initially applied directly to the pressing punches, in particular the punch shaft and/or the punch head. This reduces the amount of lubricant required and ensures that the components to be lubricated are reliably supplied with lubricant, in particular to effectively counteract wear of the pressing punches as they are guided in the punch guide. The control apparatus of the lubrication device may simultaneously be the control apparatus for controlling the operation of the rotary tablet press, i.e. the machine controller, or it may be a control apparatus designed separately from this machine controller. The rotary tablet press usually has a pressing chamber in which the rotor is arranged. This pressing chamber is usually closed off from the surroundings by a housing. The lubrication device may also be located inside the pressing chamber or else the housing. The applicator is used to apply the lubricant to the pressing punch intermittently as it moves past the applicator. The applicator can simultaneously apply lubricant to multiple pressing punches rotating past it. Multiple applicators may also be arranged along the pitch circle formed by the pressing punches, which applicators apply lubricant to passing pressing punches simultaneously or with a time delay. The applicator can also be used to apply lubricant to multiple punches rotating past it one after the other. As part of the individual control of the amount of lubricant applied according to the invention, it is also possible for no lubricant to be applied to individual pressing punches, in particular if these do not require lubricant.

Compared to the prior art, the invention thus allows for a reduction in lubricant consumption and prevents lubricant from being distributed in the pressing chamber of the rotary tablet press. This minimizes the risk of lubricant contamination on the tablets produced. At the same time, the invention allows for individual lubrication of pressing punches, in particular of the punch shaft guided in the relevant punch guide and/or the punch head cooperating with control cams and, for example, pressure rollers, such that individual pressing punches can be lubricated more or less than other pressing punches during a production process. This allows for a flexible and targeted response to different lubricant requirements, even during a production process. Excessive lubrication of pressing punches that are still well supplied with lubricant can be avoided, while at the same time reliably preventing individual pressing punches from having too little lubricant, which can, for example, impair the movement of the pressing punches within the punch guides and/or in the cavities of the die plate and increase wear. Long supply channels within the pressing chamber, in particular within the rotor of the rotary tablet press, which can become clogged, can only be cleaned with great effort and can lead to an uneven distribution of the lubricant, can be avoided according to the invention, in particular by the applicator being arranged in a fixed position relative to the rotor and being connectable to a lubricant reservoir arranged, for example, spatially close to the applicator. In particular, it is possible, for example, to lubricate all the lower pressing punches with just one applicator. The same applies to the upper pressing punches, if necessary. Of course, multiple applicators may also be provided for lubricating the lower punches and/or the upper punches. The lubricant reservoir may be arranged spatially close to the applicator, as explained. The lubricant reservoir may be located in a drive chamber of the rotary press, for example.

According to a particularly practical embodiment, the applicator may comprise at least one valve that applies lubricant from the lubricant reservoir to an outer surface of the upper and/or lower pressing punches, in particular the punch shaft and/or the punch head. Multiple valves can also be used in one applicator, which simultaneously supply one or more pressing punches with lubricant from the outside. By means of such valves, a sufficiently precise, preferably drop-shaped, application of the lubricant is possible, in particular also over a distance between the valve and the relevant pressing punch. On the other hand, valves that can be actuated particularly quickly can be used to enable lubrication of each upper and/or lower pressing punch during exactly one rotor revolution, for example, even at fast rotor speeds.

In some embodiments, the at least one valve may be arranged in an interior space, in particular of the rotor, arranged radially within a pitch circle described by the upper and/or lower pressing punches, such that the at least one valve applies the lubricant to the upper and/or lower pressing punches from the inside outwards. In this way, the lubricant can flow outwards around the pressing punch due to the centrifugal force and lubricate the entire pressing punch with lubricant. By using an applicator with at least one valve, a sufficiently compact design is also possible in order to arrange at least the at least one valve in an interior space within the rotor. In principle, the lubricant reservoir may also be arranged in the interior space. This allows for particularly short connections between the at least one valve and the lubricant reservoir. However, the lubricant reservoir may also be arranged separately therefrom. It is also possible to arrange the at least one valve outside a pitch circle described by the upper and/or lower pressing punches, such that the at least one valve applies the lubricant to the upper and/or lower pressing punches from the outside inwards.

According to a further embodiment, the at least one valve can be arranged in such a way that the lubricant is applied to the upper and/or lower pressing punches from above, from below, and/or from the side. This applies, in particular, when using multiple valves. Individual valves may also be controlled individually, for example to lubricate only the punch shaft or the punch head. On account of these designs, particularly comprehensive lubrication of the pressing punches can be achieved.

According to a further embodiment, the at least one valve may be configured to apply the lubricant intermittently at a frequency of more than 30 Hz, preferably more than 100 Hz, further preferably more than 200 Hz, further preferably no more than 250 Hz. By using a valve that can be actuated with such a high frequency, it is possible, as explained, to supply all upper or else lower pressing punches with lubricant within one rotor rotation. This also applies to the usual rotor speeds of modern rotary tablet presses. For example, with 115 pairs of rotor pressing punches and a rotor speed of 120 rpm, this would correspond to a valve actuation frequency of 230 Hz. However, as already explained, it is also possible to apply lubricant to each pressing punch within multiple rotor revolutions, wherein, for example, a lower actuation frequency can be provided.

According to a further embodiment, it can be provided that the control apparatus, in order to control the applicator, takes into account a rotary position of the rotor and/or a delay time of the applicator or a valve of the applicator and/or a flight time of the lubricant from the applicator or a valve of the applicator to an upper and/or lower pressing punch. The aforementioned parameters are decisive for determining when the applicator or else the valve for applying the lubricant must be opened in order to sufficiently wet the respectively desired pressing punch with lubricant. In particular, the flight time of the lubricant from the outlet of the valve or else applicator to the pressing punch, in particular through the air provided in the gap between them, as well as any delay time after the valve is actuated, must be taken into account. The rotary position of the rotor and thus of the pressing punch is known precisely at all times thanks to the rotary encoder that is usually provided for the rotary tablet press. Based on the likewise known rotor speed and the total delay time resulting from the flight time and valve delay, it is possible to determine the necessary rotor rotary position at which the applicator or else valve must open in order to supply the relevant pressing punch with the desired amount of lubricant. On this basis, it is possible to supply individually identified pressing punches with a defined amount of lubricant. By controlling the applicator or else the valve by means of the control unit, the individually required amount of lubricant can then be applied to the relevant individually identified pressing punch.

According to a further embodiment, it can be provided that the control apparatus, in order to ascertain the flight time of the lubricant, takes into account a lubricant pressure, a temperature of the lubricant, a viscosity of the lubricant, an opening time of the applicator or a valve of the applicator, an outlet geometry of the applicator or a valve of the applicator and/or a distance between the applicator or a valve of the applicator and an upper and/or lower pressing punch. The flight time of the lubricant from the applicator or else valve to the pressing punch depends on various parameters, in particular the lubricant pressure, the opening time of the applicator or else valve, the temperature and viscosity of the lubricant as well as the outlet geometry of the applicator or else valve and the distance between the applicator or else the valve and the pressing punch. Tests can be carried out in advance using the parameters mentioned in order to ascertain the outlet speed of the lubricant, for example a drop of lubricant. If, for example, the pressing punches in the rotary tablet press are changed between different production processes, the distances between the applicator and the pressing punch can change. These differences can be taken into account accordingly when calculating the flight time.

In some embodiments, the lubricant reservoir may also comprise a pressure apparatus that keeps the lubricant at a predefined pressure in the lubricant reservoir. The lubricant pressure should be kept as constant as possible in order to achieve reliable lubrication of the relevant pressing punch based on the calculations and parameters explained above. The pressure apparatus may, for example, comprise a lubricant pump or a cartridge with a pressure regulator. However, unpressurized solutions are also possible such that no pressure apparatus is required.

According to a further embodiment, it can be provided that the control apparatus is configured to individually control the amount of lubricant applied by the applicator to the upper and/or lower pressing punches, in particular a drop size or a number of drops or a time interval between the application of lubricant, for different upper and/or lower pressing punches by adjusting a drop size of the lubricant applied by the applicator or else the valve and/or by adjusting an opening time of the applicator or else the valve and/or by adjusting a number of lubricant applications applied by the applicator or else the valve to individual upper and/or lower pressing punches. The parameters described can be used to reliably and precisely control the amount of lubricant applied individually.

According to a further embodiment, it can be provided that the control apparatus receives measured values from at least one sensor of the rotary tablet press, wherein the control apparatus is configured to individually control the amount of lubricant applied by the applicator to the upper and/or lower pressing punches for different upper and/or lower pressing punches on the basis of the measured values received. The at least one sensor may comprise at least one stiffness sensor, which individually measures the stiffness of the upper and/or lower pressing punches, in particular in the upper or lower punch guide, respectively. Such a stiffness measurement can be used to ascertain whether and, if so, which pressing punches are more stiff in comparison to other pressing punches, in particular when moving through the upper or else lower punch guide and/or in the cavities. If increased stiffness is detected for individual pressing punches, more lubricant can be supplied to these pressing punches individually than to others. The supply of lubricant can also be suspended for particularly easily running pressing punches. In this way, further lubricant savings are possible. For example, a force sensor that records the stiffness of the pressing punches during their axial movement, in particular the force required to move the pressing punches in the relevant punch guide, as a measured value can be used as a stiffness sensor. Multiple stiffness sensors may also be provided. The stiffness sensors can measure the stiffness individually for a particular pressing punch.

According to a further embodiment, the lubricant reservoir may contain a liquid lubricant, in particular a lubricating oil, and the applicator may apply the liquid lubricant intermittently to the upper and/or lower pressing punches in drops and/or the applicator may apply the liquid lubricant to the upper and/or lower pressing punches in a defined quantity in atomized form. In any case, in this way, the lubricant can be separated and applied specifically to the respective pressing punches. In the case of atomization, in particular, defined quantities of atomized lubricant are applied to the upper and/or lower pressing punches in intermittent bursts.

According to a further embodiment, the lubrication device may have a heating apparatus for heating the applicator. This allows the desired viscosity of the lubricant to be achieved in a targeted manner for optimum lubrication.

The invention also achieves the object by means of a method for lubricating upper and/or lower pressing punches using a rotary tablet press according to the invention. The rotary tablet press is suitable and configured for carrying out the method accordingly. This applies, in particular, to the lubrication device and the control apparatus.

### BRIEF DESCRIPTION OF THE DRAWINGS

An exemplary embodiment of the invention is explained below in greater detail based on figures.

FIG. 1 schematically illustrates a flattened perspective of an embodiment of a rotary tablet press according to the invention.

FIG. 2 schematically illustrates a representation of the lubrication device of the rotary tablet press according to the invention using an example of an upper pressing punch.

FIG. 3 schematically illustrates a sectional plan view of a part of the rotary tablet press according to the invention.

If not otherwise specified, the same reference signs denote the same objects in the figures.

### DETAILED DESCRIPTION OF THE INVENTION

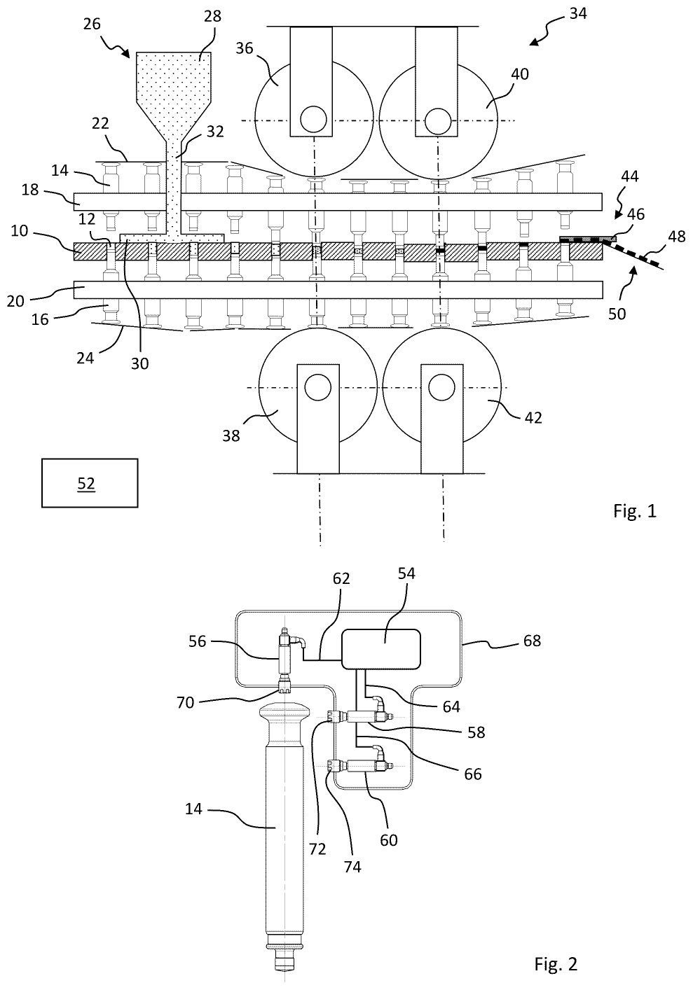

In the embodiment of the rotary tablet press shown in FIG. 1, powdered material is pressed into tablets. In some embodiments, the rotary tablet press comprises a rotor driven in rotation by a rotary drive in a pressing chamber 11 and having a die plate 10, which has a plurality of cavities 12. The cavities 12 can be formed, for example, by bores in the die plate 10. The rotor further comprises multiple upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. The rotary tablet press further comprises a filling apparatus 26, which has a filling reservoir 28 and a filling chamber 30 which are connected via a filling tube 32. In this way, in the present example, powdered material arrives due to gravity from the filling reservoir 28 via the filling tube 32 into the filling chamber 30 and from there via a filling opening provided on the lower side of the filling chamber 30 into the cavities 12 of the die plate 10 again due to gravity.

The rotary tablet press further comprises a pressure apparatus 34. The pressure apparatus 34 comprises a pre-pressure apparatus having an upper pre-pressure roller 36 and a lower pre-pressure roller 38 as well as a main pressure apparatus having an upper pressure roller 40 and a lower pressure roller 42. Furthermore, the rotary tablet press comprises an ejection apparatus 44 and a scraper apparatus 46 having a scraper element which supplies the tablets 48 produced in the rotary tablet press to a discharge apparatus 50 for discharging from the rotary tablet press. The scraper apparatus 46 may, for example, comprise a preferably crescent-shaped scraper element which scrapes tablets 48 conveyed by the lower pressing punches 16 onto the upper side of the die plate 10 in the region of the ejection apparatus 44 off of the die plate 10 and supplies them to the discharge apparatus 50. The rotary tablet press also comprises a control apparatus 52, in particular a machine controller 52, for controlling the operation of the rotary tablet press and for controlling the lubrication device according to the invention, as explained in more detail below.

FIG. 2 shows a lubrication device provided in the rotary tablet press according to FIG. 1 using the example of lubrication of the upper pressing punch 14. The lubrication device comprises a lubricant reservoir 54 in which, for example, a liquid lubricant such as lubricating oil is contained. The lubricant in the lubricant reservoir 54 can be kept under a predefined, in particular constant, pressure by means of a pressure apparatus not shown in more detail. In the example shown, an applicator of the lubrication device comprises three valves 56, 58, 60, each of which is connected to the lubricant reservoir 54 via short connecting lines 62, 64, 66. Both the lubricant reservoir 54 and the valves 56, 58, 60 including the connecting lines 62, 64, 66 may be arranged in an interior space 68 preferably arranged inside the rotor or rotary tablet press and do not rotate with the rotor of the rotary tablet press. However, it is also possible, for example, to arrange the lubricant reservoir 54 outside the interior space 68 and to convey the lubricant via connecting lines from the lubricant reservoir 54 into the interior space 68 and to the valves 56, 58, 60. The valves 56, 58, 60 each have an outlet opening 70, 72, 74, in particular outlet nozzle 70, 72, 74. In the present case, the outlet openings 70, 72, 74 are directed towards different regions of the outer surface of the upper pressing punches 14. In particular, the valve 56 with its outlet opening 70 is directed towards the upper side of the punch head and the valves 58 and 60 with their outlet openings 72, 74 are directed at different heights towards the punch shaft of the upper pressing punch 14. The outlet openings 70, 72, 74 are each arranged at a distance from the upper pressing punch 14.

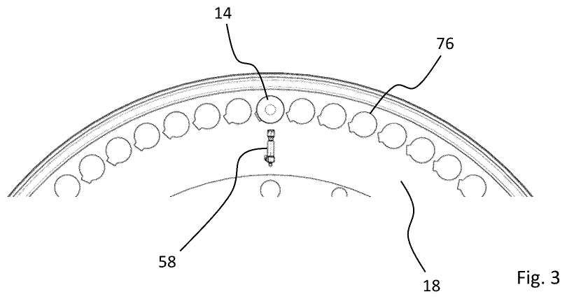

During operation of the rotary tablet press, lubricant is applied from the lubricant reservoir 54 onto the outer surface of the upper pressing punches 14 via the outlet openings 70, 72, 74, controlled by the control apparatus 52. It should be noted that FIG. 2 shows three valves 56, 58, 60 arranged in the interior space 68 by way of example. It is possible that the lubrication device has, for example, only one or only two of the valves 56, 58, 60 shown. Alternatively or additionally, the lubrication device may also have further valves that can wet other regions of the outside of the upper pressing punches 14 with lubricant. As explained, the lubrication device is explained using the example of lubrication of the upper pressing punches 14. A lubrication device for the lower pressing punches 16 may be configured in the same way. During operation, the upper pressing punches 14 rotate past the stationary lubrication device as the rotor rotates. FIG. 3 shows an example of this in a view from above of the upper punch guide 18. The punch guide 18 has punch guide bores 76, in which the upper pressing punches 14 are axially guided by their punch shafts. In FIG. 3, only the valve 58 is shown as an example for illustration purposes.

The rotary tablet press further comprises multiple sensors which measure various parameters during operation, for example the pressing force and/or the stiffness of the pressing punches 14, 16 in the punch guides 18, 20. The measured values from the sensors are available at the control apparatus 52. The control apparatus controls, for example on the basis of the measured values of a stiffness sensor, the applicator of the lubrication device, in particular the valves 56, 58, 60 for individual lubrication of the upper pressing punches 14. If, for example, the stiffness sensor detects that individual upper pressing punches 14 are stiff, the valves 56, 58, 60, controlled by the control apparatus 52, wet these upper pressing punches 14 in a targeted manner with a larger amount of lubricant. For example, a drop size of the applied lubricant can be adjusted for this purpose. A quantity of atomized lubricant can also be adjusted. Furthermore, the duration of lubricant application and/or the number of lubricant bursts applied can be adjusted. It is also conceivable that the valves 56, 58, 60 are individually controlled by the control apparatus 52, for example to apply more or less lubricant to specific regions of the pressing punches 14 in a targeted manner.

The valves 56, 58, 60 may be designed to apply lubricant intermittently at a frequency of more than 30 Hz, preferably more than 100 Hz, further preferably more than 200 Hz, further preferably not more than 250 Hz. In this way, even with a large number of upper pressing punches 14 and a high rotor speed, it is possible to supply all upper pressing punches 14 with lubricant during a rotor rotation.

In order to supply specific upper pressing punches 14 with a predefined amount of lubricant in a targeted manner, the control apparatus, in order to control the applicator or else the valves 56, 58, 60, takes into account a rotary position of the rotor and/or a delay time of the valves 56, 58, 60 and/or a flight time of the lubricant from the valves 56, 58, 60 to the upper pressing punches 14, as explained above.

### REFERENCE SIGNS

10 Die plate
12 Cavities
14 Upper pressing punches
16 Lower pressing punches
18 Upper punch guide
20 Lower punch guide
22 Upper control cam elements
24 Lower control cam elements
26 Filling apparatus
28 Filling reservoir
30 Filling chamber
32 Filling tube
34 Pressure apparatus
36 Upper pre-pressure roller
38 Lower pre-pressure roller
40 Upper pressure roller
42 Lower pressure roller
44 Ejection apparatus
46 Scraper apparatus
48 Tablets
50 Discharge apparatus
52 Control apparatus
54 Lubricant reservoir
56, 58, 60 Valves
62, 64, 66 Connecting lines
68 Interior space
70, 72, 74 Outlet openings
76 Punch guide bores

1. A rotary tablet press, comprising:
a rotor configured to be driven by a rotary drive, wherein the rotor includes,
an upper punch guide for upper pressing punches,
a lower punch guide for lower pressing punches, and
a die plate arranged between the upper and lower punch guides and comprising a plurality of cavities, wherein the upper and lower pressing punches are configured to cooperate with the plurality of cavities of the die plate;
a filling apparatus configured to deposit powder material to be pressed into the plurality of cavities of the die plate;
a pressure apparatus comprising an upper pressure unit and a lower pressure unit that are configured to cooperate with the upper pressing punches and with the lower pressing punches during operation in order to press the powder material in the plurality of cavities of the die plate into tablets;
an ejection apparatus configured to eject the tablets from the plurality of cavities; and
a lubrication device configured to lubricate at least one of the upper and the lower pressing punches with a lubricant, wherein the lubrication device comprises,
a lubricant reservoir configured to hold a lubricant,
a stationary applicator connected to the lubricant reservoir and configured to apply the lubricant to at least one of the upper pressing punches and the lower pressing punches rotating past the stationary applicator, and
a control apparatus configured to individually control an amount of lubricant applied by the stationary applicator to the at least one of the upper pressing punches and the lower pressing punches for different upper or lower pressing punches.

2. The rotary tablet press according to claim 1, wherein the applicator further comprises at least one valve that is configured to apply the lubricant from the lubricant reservoir to an outer surface of the at least one of the upper pressing punches and the lower pressing punches.

3. The rotary tablet press according to claim 2, wherein the at least one valve is arranged in an interior space and positioned radially within a pitch circle described by the at least one of the upper and the lower pressing punches, wherein the at least one valve is configured to apply the lubricant to the at least one of the upper and the lower pressing punches from an inside outwards.

4. The rotary tablet press according to claim 2, wherein the at least one valve is configured such that the lubricant is applied to the at least one of the upper and lower pressing punches from at least one of: (i) above; (ii) from below; and (iii) from a side.

5. The rotary tablet press according to claim 2, wherein the at least one valve is configured to apply the lubricant intermittently at a frequency of more than 30 Hz.

6. The rotary press according to claim 2, wherein the at least one valve is configured to apply the lubricant intermittently at a frequency of more than 250 Hz.

7. The rotary tablet press according claim 2, wherein the control apparatus controls the applicator by taking into account at least one of: (i) a rotary position of the rotor; (ii) a delay time of the applicator or a valve of the applicator; and (iii) a flight time of the lubricant from the applicator or the at least one valve of the applicator to one of the upper and the lower pressing punches.

8. The rotary tablet press according to claim 7, wherein the control apparatus is configured to ascertain the flight time of the lubricant by accounting for one or more of: (i) a lubricant pressure; (ii) a temperature of the lubricant; (iii) a viscosity of the lubricant; (iv) an opening time of the applicator or a valve of the applicator; (v) an outlet geometry of the applicator or a valve of the applicator; (vi) a distance between the applicator or a valve of the applicator; and (vii) an upper and/or lower pressing punch.

9. The rotary tablet press according to claim 1, wherein the lubricant reservoir further comprises a pressure apparatus configured to keep the lubricant at a predefined pressure.

10. The rotary tablet press according to claim 1, wherein the control apparatus is further comprised to individually control the amount of lubricant applied by the applicator to at least one of the upper and lower pressing punches for different upper and/or lower pressing punches by adjusting a drop size of the lubricant applied by the applicator and/or by at least one of; (i) adjusting an opening time of the applicator; and (ii) adjusting a number of lubricant applications applied by the applicator to individual pressing punches.

11. The rotary tablet press according to claim 1, wherein the control apparatus is configured to receive measured values from at least one sensor of the rotary tablet press, and wherein the control apparatus is configured to individually control an amount of lubricant applied by the applicator to at least one of the upper and lower pressing punches for different pressing punches on a basis of the measured values received.

12. The rotary tablet press according to claim 11, wherein the at least one sensor includes at least one stiffness sensor that is configured to measure the stiffness of at least one of the upper and the lower pressing punches.

13. The rotary tablet press according to claim 1, wherein the lubricant reservoir is configured to contain a liquid lubricant, and wherein the applicator is configured to apply the liquid lubricant intermittently to at least one of the upper and the lower pressing punches in drops or in a defined quantity in atomized form.

14. The rotary tablet press according to claim 1, wherein the lubrication device comprises a heating apparatus configured to heat the applicator.

15. A method for lubricating at least one of upper and lower pressing punches of a the rotary tablet press, comprising:
structuring the rotary tablet press to include a lubrication device;
structuring the lubrication device to include a lubricant reservoir configured to hold a lubricant;
structuring the lubrication device to include a stationary applicator that is connected to the lubricant reservoir and configured to apply the lubricant to at least one of the upper pressing punches and the lower pressing punches as the at least one of the upper and the lower pressing punches rotate past the stationary applicator; and
structuring a control apparatus to individually control an amount of lubricant applied by the stationary applicator to the at least one of the upper pressing punches and the lower pressing punches for different upper or lower pressing punches.
